(19) United States
(12) Patent Application Publication
(10) Pub. No.: US 2007/0026264 A1
(43) Pub. Date: Feb. 1, 2007

(54) MAGNETIC RECORDING MEDIUM

(75) Inventors: Takayoshi Kuwajima, Tokyo (JP); Akinori Nishizawa, Tokyo (JP); Akihiko Seki, Tokyo (JP)

Correspondence Address: GREENBLUM & BERNSTEIN, P.L.C., 1950 ROLAND CLARKE PLACE, RESTON, VA, 20191, US

(73) Assignee: TDK CORPORATION, Tokyo (JP)

(21) Appl. No.: 11/461,051

(22) Filed: Jul. 31, 2006

(30) Foreign Application Priority Data
Aug. 1, 2005 (JP) 2005/222402

(51) Int. Cl. G11B 5/716; G11B 5/71

(52) U.S. Cl. 428/840.2; 428/840.4; 428/842; 428/843.3; 428/845.3; 428/845.5

(57) ABSTRACT

A magnetic recording medium has a non-magnetic layer and a magnetic layer formed in that order on one surface of a non-magnetic support and a back coat layer formed on the other surface of the non-magnetic support. The non-magnetic layer is formed so as to include at least one of α-iron oxide and α-iron hydroxide. The magnetic layer is formed so as to include a ferromagnetic alloy powder. The back coat layer is formed so as to include carbon black, and barium sulfate. At least one of the non-magnetic layer and the magnetic layer includes lubricant. The layers are formed so that the amount of SO₄²⁻ eluted when the magnetic recording medium is immersed in water at 70° C. is in a range of 300 ppm to 600 ppm inclusive relative to the weight of the magnetic recording medium.

### BACKGROUND OF THE INVENTION

1. Field of the Invention

The present invention relates to a magnetic recording medium where at least a magnetic layer is formed on one surface of a non-magnetic support and a back coat layer is formed on the other surface of the non-magnetic support.

2. Description of the Related Art

As one example of this type of magnetic recording medium, a magnetic recording medium (magnetic tape or the like) disclosed by Japanese Laid-Open Patent Publication No. H01-173424 is known. This magnetic recording medium is constructed by forming a magnetic layer on one surface of a support and forming a back coat layer on the other surface of the support. The magnetic layer is formed so as to include a ferromagnetic material, a binder (resin material), a hardener, a dispersant, an antistatic agent, and the like. The back coat layer is formed so as to include non-magnetic powder, a binder, a hardener, a dispersant, and the like. Also, with this magnetic recording medium, a lubricant is included in the magnetic layer to improve the running characteristics. As the non-magnetic powder included in the back coat layer, carbon black and barium sulfate are used. By including carbon black and barium sulfate as the non-magnetic powder, it is possible to improve the running characteristics of the magnetic recording medium, and as a result, compared to a magnetic recording medium that includes inorganic powder as the non-magnetic powder, the occurrence of damage during running can be partially avoided, thereby improving durability.

### SUMMARY OF THE INVENTION

However, by investigating the conventional magnetic recording medium described above, the present inventors found the following problem. That is, with the conventional magnetic recording medium described above, to improve the running characteristics (i.e., to improve the durability), lubricant is included in the magnetic layer and carbon black and barium sulfate are used as the non-magnetic powder included in the back coat layer. There is a tendency with this type of magnetic recording medium for the recording density to rise as the storage capacity for recording data increases. As the recording density of data is increased, it becomes easier for recording/reproducing errors to occur due to poor running characteristics, and therefore it is necessary to significantly improve the running characteristics. However, when a large amount of barium sulfate is included in the back coat layer to improve the running characteristics, foreign matter including fatty acid salts is produced from the magnetic recording medium. Such foreign matter adheres to the magnetic head or the like of a recording/reproducing apparatus, resulting in recording/reproducing errors. On the other hand, when the included amount of barium sulfate is reduced to an extreme degree to prevent foreign matter from being produced, there is a reduction in the strength of the back code layer, resulting in lower durability for the magnetic recording medium. In this way, with the conventional magnetic recording medium where there is the risk of foreign matter being produced or of a fall in durability, there is the problem that it is difficult to respond to demands for an increase in recording density to raise the data recording capacity.

The present invention was conceived to solve the problems described above and it is a principal object of the present invention to provide a magnetic recording medium that can respond to demands for an increase in recording density to raise the data recording capacity.

To achieve the stated object, a magnetic recording medium according to the present invention has at least a non-magnetic layer and a magnetic layer formed in the mentioned order on one surface of a non-magnetic support and a back coat layer formed on the other surface of the non-magnetic support, wherein the non-magnetic layer is formed so as to include resin material and at least one of α-iron oxide and α-iron hydroxide, the magnetic layer is formed so as to include a ferromagnetic alloy powder and a resin material, the back coat layer is formed so as to include carbon black, barium sulfate, and a resin material, at least one of the non-magnetic layer and the magnetic layer includes lubricant, and the non-magnetic layer, the magnetic layer, and the back coat layer are formed so that an amount of SO₄²⁻ eluted when the magnetic recording medium is immersed in water at 70° C. is in a range of 300 ppm to 600 ppm inclusive relative to a weight of the magnetic recording medium. Note that the magnetic recording medium according to the present invention is not limited to a magnetic recording medium where only a non-magnetic layer and a magnetic layer are laminated on a non-magnetic support, and includes a magnetic recording medium where various functional layers are formed between the non-magnetic support and the non-magnetic layer, a magnetic recording medium where various functional layers are formed between the non-magnetic layer and the magnetic layer, and a magnetic recording medium where various functional layers are formed on the magnetic layer.

According to the above construction, for a magnetic recording medium where at least one of the non-magnetic layer and the magnetic layer includes lubricant, the non-magnetic layer includes at least one of α-iron oxide and α-iron hydroxide, and the back coat layer includes barium sulfate, by forming the non-magnetic layer, the magnetic layer, and the back coat layer so that the amount of SO₄²⁻ eluted when the magnetic recording medium is immersed in water at 70° C. is in a range of 300 ppm to 600 ppm inclusive relative to the weight of the magnetic recording medium, it is possible to reduce the amount of α-iron oxide and α-iron hydroxide included in the non-magnetic layer that is ionized to form Fe⁺ to within a suitable range, and therefore it is possible to reduce the produced amount of fatty acid iron that is the main constituent of fatty acid salts and by doing so sufficiently reduce the produced amount of foreign matter. Therefore, according to the above magnetic recording medium, it is possible to avoid recording/reproducing errors due to adhering foreign matter. Also, since it is possible to include a sufficient amount of barium sulfate in the back coat layer, the strength of the back coat layer can be sufficiently improved and therefore the durability of the magnetic recording medium can be sufficiently increased. By doing so, it is possible to provide a magnetic recording medium that can respond to demands for an increase in recording density to raise the data recording capacity.

It should be noted that the disclosure of the present invention relates to a content of Japanese Patent Application 2005-222402 that was filed on 1 Aug. 2005 and the entire content of which is herein incorporated by reference.

### BRIEF DESCRIPTION OF THE DRAWINGS

These and other objects and features of the present invention will be explained in more detail below with reference to the attached drawings, wherein:

FIG. 1 is a cross-sectional view of a magnetic tape that is one example of a magnetic recording medium according to the present invention; and

FIG. 2 is a table useful in showing an included amount of barium sulfate, whether surface treatment is carried out, an eluted amount of soluble ions, whether foreign matter adheres, and whether there is damage to a back coat layer for each of examples 1 to 4 and comparative examples 1 to 3.

### DESCRIPTION OF THE PREFERRED EMBODIMENTS

Preferred embodiments of a magnetic recording medium according to the present invention will now be described with reference to the attached drawings.

First, the construction of a magnetic tape 1 that is one example of a magnetic recording medium according to the present invention will be described with reference to the attached drawings.

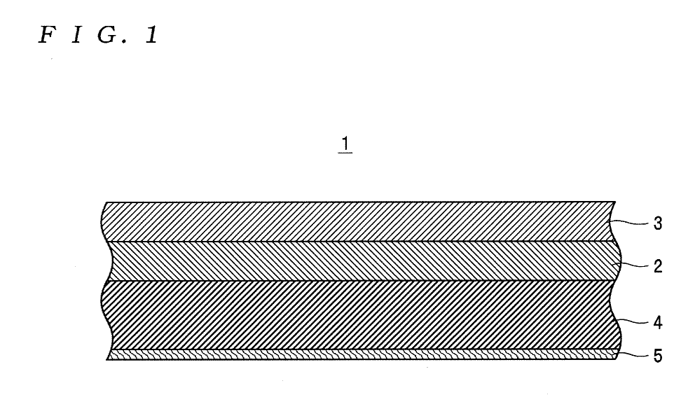

A magnetic tape 1 shown in FIG. 1 has a non-magnetic layer 2 and a magnetic layer 3 formed in the mentioned order on one surface (the upper surface in FIG. 1) of a base film 4, and is constructed so that various types of data can be recorded and reproduced by a recording/reproducing apparatus, not shown. A back coat layer 5 for improving the running characteristics of the tape and preventing the magnetic tape 1 from becoming electrically charged is formed on the other surface (the lower surface in FIG. 1) of the base film 4. Note that in FIG. 1, for ease of understanding the present invention, the thickness of the magnetic tape 1 has been exaggerated and the ratio of thicknesses of the various layers has been shown differently to the actual ratio. Also, to improve adhesion of the non-magnetic layer 2 to the base film 4, a primer layer (adhesion-enhancing layer) may be provided between the base film 4 and the non-magnetic layer 2.

Base Film

The base film 4 corresponds to the “non-magnetic support” for the present invention, and after the various layers have been formed, the base film 4 and the layers are cut into predetermined widths that are set for various types of magnetic recording media. The base film 4 is formed in a long belt-like form using a resin material such as polyester (for example, polyethylene terephthalate (PET) or polyethylene naphthalate (PEN)), polyolefin (for example, polypropylene), polyamide, polyimide, polyamide-imide, polysulfone-cellulose triacetate, and polycarbonate. To achieve sufficient strength, the thickness of the base film 4 should preferably be set at 3.0 μm or greater. Also, to increase the recording capacity (i.e., to reduce the diameter when the magnetic recording medium is wound), the thickness of the base film 4 should preferably be set at 10.0 μm or smaller. Note that although the base film 4 is formed in a long belt-like form (i.e., a tape shape) in the present embodiment, the base film 4 may be formed in a variety of shapes such as a sheet, a card, or a disk.

Non-Magnetic Layer

The non-magnetic layer 2 is formed by applying a non-magnetic coating composition fabricated so as to include non-magnetic powder, an electron beam-curing binder, a dispersant, a thermosetting agent, and a lubricant so that the thickness of the non-magnetic layer 2 is in a range of 0.3 μm to 2.5 μm, inclusive. If the thickness of the non-magnetic layer 2 is below 0.3 μm, the non-magnetic layer 2 is susceptible to being affected by the surface roughness of the base film 4, resulting in deterioration in the smoothness of the surface of the non-magnetic layer 2. Accordingly, there is deterioration in the smoothness of the surface of the magnetic layer 3 formed on the non-magnetic layer 2, resulting in deterioration in the electromagnetic conversion characteristics of the magnetic tape 1 and in difficulty in recording data properly. Also, if the thickness is below 0.3 μm, there is an increase in the light transmission of the non-magnetic layer 2, making it difficult to optically detect (i.e., to detect via a change in light transmission) the end of the magnetic tape 1 during the recording and reproducing of data. On the other hand, even if the non-magnetic layer 2 is formed with a thickness of over 2.5 μm, there will be no great improvement in the recording characteristics of the magnetic tape 1 and conversely it becomes difficult to form the non-magnetic layer 2 with a uniform thickness. In addition, since a large amount of non-magnetic coating composition will be used to form the non-magnetic layer 2 when the non-magnetic layer 2 is over 2.5 μm thick, there is the risk of an increase in the manufacturing cost of the magnetic tape 1.

As the non-magnetic powder, it is possible to use carbon black and a variety of non-carbon black non-magnetic inorganic powders. As the carbon black, it is possible to use furnace black used in rubber products, thermal black used in rubber products, black used in printing, acetylene black, or the like. Here, the BET specific surface area should preferably be within a range of 5 m²/g to 600 m²/g, inclusive, the DBP oil absorption within a range of 30 ml/100 g to 400 ml/100 g, inclusive, and the average particle diameter in a range of 10 nm to 100 nm, inclusive. The carbon black that can be used can be decided by referring to the “Carbon Black Handbook” (produced by the Carbon Black Association). The proportion of carbon black in the non-magnetic layer 2 should preferably be in a range of 5% by weight to 30% by weight inclusive. Here, to significantly lower the surface electrical resistance, the proportion of the carbon black should preferably be at least 10% by weight. To keep the surface roughness of the non-magnetic layer 2 favorable, the proportion of carbon black in the non-magnetic layer 2 should preferably be 25% by weight or lower. Accordingly, the proportion of carbon black in the non-magnetic layer 2 should more preferably be in a range of 10% by weight to 25% by weight, inclusive.

As the non-carbon black non-magnetic inorganic powder, it is possible to use an acicular non-magnetic iron oxide such as α-iron oxide or α-iron hydroxide, or a mixture of the same. Also, the mixed proportions of the carbon black and the non-carbon black non-magnetic inorganic powder should preferably be set so that the weight ratio (carbon black: non-magnetic inorganic powder) is in a range of 30:70 to 5:95, inclusive. If the proportion (by weight) of carbon black is too small, there is an increase in the surface electrical resistance of the magnetic tape 1, which makes it easy for dust to adhere. Such adhering dust can cause drop outs (recording/reproducing errors). Also if the proportion (by weight) of carbon black is too small, when a recording/reproducing process is carried out by a recording/reproducing apparatus equipped with an MR head, there is the risk of electrostatic breakdown of the MR head. On the other hand, if the proportion (by weight) of carbon black is too large, there is deterioration in the surface roughness of the non-magnetic layer 2, which causes deterioration in the surface roughness of the magnetic layer 3 (i.e., the surface roughness of the magnetic tape 1) and can result in an increased error rate for the magnetic tape 1.

Examples of the electron-beam curing binder (one example of a “resin material” for the present invention) include polyurethane resin, (meth)acrylic resin, polyester resin, vinyl chloride-based copolymer (such as vinyl chloride-epoxy-based copolymer, vinyl chloride-vinyl acetate-based copolymer, or vinyl chloride-vinylidene chloride copolymer), acrylonitrile-butadiene-based copolymer, polyamide resin, polyvinyl butyral-based resin, nitrocellulose, styrene-butadiene-based copolymer, polyvinyl alcohol resin, acetal resin, epoxy-based resin, phenoxy-based resin, polyether resin, polyfunctional polyether such as polycaprolactone, polyimide resin, phenol resin, and polybutadiene elastomer that have been altered so as to become curable by an electron beam. As one example, a vinyl chloride-based copolymer and polyurethane-based resin are used as the electron beam-curing binder of the magnetic tape 1 (the non-magnetic layer 2).

As the vinyl chloride-based copolymer, a copolymer including 40% by weight to 95% by weight inclusive of vinyl chloride should preferably be used. If the included amount of vinyl chloride is too small, there is the risk of the coating film (the non-magnetic layer 2) having insufficient mechanical strength, resulting in a fall in the reliability of the magnetic tape 1. Accordingly, it is more preferable for the included amount of vinyl chloride to be at least 50% by weight. If the included amount of vinyl chloride is too large, the pliancy of the coating film (the non-magnetic layer 2) falls, resulting in the risk of a fall in the reliability of the magnetic tape 1. Accordingly, it is more preferable for the included amount of vinyl chloride to be 90% by weight or less. The average degree of polymerization of the vinyl chloride-based copolymer is preferably in a range of 100 to 500, inclusive. In particular, a copolymer of vinyl chloride and a monomer including an epoxy (glycidyl) group should preferably be used as the vinyl chloride copolymer. The vinyl chloride-based copolymer can be altered so as to become curable by an electron beam by introducing a (meth)acrylic double bond or the like using a well-known method. Also, “polyurethane resin” in the present specification is a general name for a resin produced by a reaction between a hydroxy group-containing resin, such as polyester polyol and/or polyether polyol, and a polyisocyanate-containing compound. Such polyurethane resin has a number-average molecular weight of around 5,000 to 200,000, inclusive and a Q value (weight-average molecular weight/number-average molecular weight) in a range of 1.5 to 4, inclusive. The polyurethane resin may be altered to an electron beam-curing resin by introducing a (meth)acrylic double bond using a well-known method.

The included amount of electron beam-curing binder in the non-magnetic layer 2 should preferably be in a range of 10 parts by weight to 100 parts by weight, inclusive relative to 100 parts by weight of the total of the carbon black and the non-carbon black non-magnetic inorganic powder in the non-magnetic layer 2. If the included amount of electron beam-curing binder is too small, the proportion of the electron beam-curing binder in the non-magnetic layer 2 falls and sufficient strength is not achieved for the coating film. For this reason, the included amount of electron beam-curing binder should more preferably be at least 12 parts by weight. On the other hand, if the included amount of electron beam-curing binder is too large, in the case of a tape-like medium such as a magnetic tape, the tape will be susceptible to becoming prominently bent in the width direction of the tape, resulting in a tendency for poor contact with a magnetic head. For this reason, the included amount of electron beam-curing binder should more preferably be 30 parts by weight or less. Accordingly, the included amount of electron beam-curing binder in the non-magnetic layer 2 should preferably be in a range of 12 parts by weight to 30 parts by weight, inclusive.

As the dispersant, it is preferable to use a resin with an amine group (at least one out of a primary amine (−NH₂), a secondary amine, and a tertiary amine) as the polar group since this results in high reactivity with the thermal hardener and is effective in raising the crosslinking characteristics of the non-magnetic layer 2. When the dispersant is used together with an electron beam-curing binder, to achieve favorable crosslinking characteristics, it is necessary to use a dispersant that is highly reactive with the thermal hardener. The amount of dispersant included in the non-magnetic layer 2 should preferably be in a range of 1 part by weight to 6 parts by weight inclusive relative to a total of 100 parts by weight of the non-magnetic powder. If the included amount of dispersant is too small, the coating composition will be insufficiently dispersed, resulting in deterioration in the surface characteristics of the non-magnetic layer 2 and the cross-linking reaction will be insufficient, resulting in difficulty in obtaining sufficient strength for the coating film. On the other hand, if the included amount of dispersant is too large, the cross-linking reaction with the thermal hardener is promoted, resulting in lower stability for the non-magnetic coating composition. As the resin that includes an amine group as a polar group, it is possible to use at least one type of anionic surfactant selected out of a carboxylic acid amine salt, a phosphoric acid ester amine salt, and a polyester acid amide amine salt, for example.

As the thermal hardener, it is preferable to use a hardener that includes an organic compound with an isocyanate group (NCO) and undergoes a hardening reaction between the isocyanate group and the thermal hardening reactive group of the dispersant described above. If the included amount of thermal hardener is too small, the cross-linking reaction is insufficient, making it difficult to achieve sufficient strength for the coating film. Accordingly, the included amount of thermal hardener should preferably be at least 0.2 parts by weight relative to 1 part by weight of dispersant in the non-magnetic layer 2. Conversely, if the included amount of thermal hardener is too great, the cross-linking characteristics become excessive, which leads to problems such as poor contact with the magnetic head. Accordingly, the included amount of thermal hardener should preferably be 2 parts by weight or less. As a specific example of the cross-linking agent, it is possible to use a polyisocyanate oligomer (isocyanurate hardener) that has a typical isocyanurate ring inside the molecule. More specifically, it is possible to use an diisocyanate compound such as TDI (tolylene diisocyanate), MDI (diphenyl methane diisocyanate), IPDI (isophorone diisocyanate), HDI (hexamethylene diisocyanate), XDI (xylylene diisocyanate), hydrogenated XDI, o-phenylene diusocyanate, m-phenylene diisocyanate, and p-phenylene diisocyanate, or an oligomer of such diisocyanate compounds.

Various well-known resins may be included in the non-magnetic layer 2 in a range of 20% by weight or less of the electron beam-curing binder (the vinyl chloride-based copolymer and polyurethane resin). As one example, to improve the crosslinking rate of the electron beam-curing binder, as necessary it is possible to include an electron beam-curing polyfunctional monomer as a crosslinking agent, and in such case, polyfunctional (meth)acrylate should preferably be used. There are no particular limitations on the polyfunctional (meth)acrylate used, and ethylene glycol di(meth)acrylate, diethylene glycol di(meth)acrylate, polyethylene glycol di(meth)acrylate, 1,6-hexane glycol di(meth)acrylate, pentaerythritol tetra(meth)acrylate, trimethylol propane tri(meth)acrylate, and trimethylol propane di(meth)acrylate can be given as examples.

Also, as the lubricant, it is possible to use one or a mixture of two or more well-known substances such as a fatty acid such as stearic acid and myristic acid, a fatty acid ester such as butyl stearate and butyl palmitate, or a sugar, regardless of whether such substances are saturated or unsaturated. Since it is necessary to constantly supply a lubricant suited to all of the temperature environments in which the magnetic tape 1 will be used to the surface of the magnetic tape 1 (the surface of the magnetic layer 3), it is preferable to use a mixture of two or more fatty acids with different melting points or a mixture of two or more fatty acid esters with different melting points. The amount of lubricant included in the non-magnetic layer 2 can be adjusted as appropriate according to use, but if the included amount is too small, the running characteristics cannot be sufficiently improved, while if the included amount is too large, there is the risk of a large amount of lubricant adhering to the magnetic head as described later, resulting in deterioration in the recording/reproducing characteristics. Accordingly, the included amount of lubricant should preferably be in a range of 1% by weight to 20% by weight inclusive relative to the total weight of the carbon black and the non-carbon black non-magnetic inorganic powder in the non-magnetic layer 2. Note that since the lubricant included in the non-magnetic layer 2 permeates through the magnetic layer 3 and is supplied to the surface of the magnetic layer 3 during the long-term use of the magnetic tape 1, if a sufficient amount of lubricant can be included in the magnetic layer 3, the magnetic tape 1 can be constructed with no lubricant included in the non-magnetic layer 2.

The non-magnetic coating composition for forming the non-magnetic layer 2 is prepared using a well-known method where an organic solvent is added to the various substances described above and processes such as mixing, agitating, kneading, and dispersing are carried out. There are no particular limitations on the organic solvent used, and it is possible to select and use one or a mixture of two or more solvents such as ketone solvents (for example, methyl ethyl ketone (MEK), methyl isobutyl ketone, and cyclohexanone) and aromatic solvents (for example, toluene). The added amount of organic solvent can be set in a range of 100 parts by weight to 900 parts by weight inclusive relative to 100 parts by weight of the total of the solid content (carbon black, the non-carbon black non-magnetic inorganic powder, and the like), the electron beam-curing binder, the dispersant and the thermal hardener.

Magnetic Layer

The magnetic layer 3 is formed by applying a magnetic coating composition fabricated so as to include a ferromagnetic powder, a binder, and the like, and is formed with a thickness in a range of 0.03 μm to 0.30 μm, inclusive (as one example, around 0.10 μm in the present embodiment). If the magnetic layer 3 is too thin, there is the risk that sufficient magnetic recording characteristics cannot be obtained. For this reason, the magnetic layer 3 should preferably be at least 0.05 μm thick. Conversely, if the magnetic layer 3 is too thick, the self-demagnetization loss and thickness loss become large. For this reason, the thickness of the magnetic layer 3 should preferably be 0.25 μm or below. Accordingly, the thickness of the magnetic layer 3 should more preferably be in a range of 0.05 μm to 0.25 μm, inclusive.

As the ferromagnetic powder ( “ferromagnetic alloy powder” for the present invention), metal magnetic powder or hexagonal plate-shaped fine powder should preferably be used. For the metal magnetic powder, the coercitivity Hc should preferably be in a range of 118.5 kA/m to 237 kA/m (1500 Oe to 3000 Oe), inclusive, the saturation magnetization σs in a range of 90 Am²/kg (emu/g) to 160 Am²/kg (emu/g), inclusive, the average major axis length (the average major axis diameter) in a range of 0.03 μm to 0.1 μm, inclusive, the average minor axis length (the average minor axis diameter) in a range of 7 nm to 20 nm, inclusive, and the aspect ratio in a range of 1.2 to 20 inclusive. The coercitivity Hc of a magnetic tape 1 fabricated using the metal magnetic powder should preferably be in a range of 118.5 kA/m to 237 kA/m (1500 Oe to 3000 Oe), inclusive.

In addition, as additive elements for the ferromagnetic powder, according to the intended purpose, it is possible to use Ni, Zn, Co, Al, Si, Y, or another rare earth. For the hexagonal plate-shaped fine powder, the coercitivity Hc should preferably be in a range of 79 kA/m to 237 kA/m (1000 Oe to 3000 Oe), inclusive, the saturation magnetization σs in a range of 50 Am²/kg (emu/g) to 70 Am²/kg (emu/g), inclusive, the average plate particle diameter in a range of 30 nm to 80 nm, inclusive, and the plate ratio in a range of 3 to 7, inclusive. The coercitivity Hc of a magnetic tape 1 fabricated using the hexagonal plate-shaped fine powder should preferably be in a range of 94.8 kA/m to 238.7 kA/m (1200 Oe to 3000 Oe) inclusive. As additive elements for the hexagonal plate-shaped fine powder, according to the intended purpose, it is possible to use Ni, Co, Ti, Zn, Sn, or another rare earth.

Here, the average major axis length of the ferromagnetic powder can be found by separating and extracting the ferromagnetic powder from a tape fragment of the magnetic tape 1 and then measuring the major axis length of the ferromagnetic powder from a photograph taken by a transmission electron microscope (TEM). One example of this procedure is given below.
(1) The back coat layer 5 is peeled off and removed from the tape fragment using a solvent.
(2) The tape fragment sample where the non-magnetic layer 2 and the magnetic layer 3 remain on the base film 4 is soaked in a 5% aqueous solution of NaOH, and simultaneously heated and agitated.
(3) The coating films that have fallen off the base film 4 are washed and dried.
(4) The dried coating films are ultrasonically treated in methyl ethyl ketone (MEK) and the magnetic powder is magnetically attracted to and collected by a magnetic stirrer.
(5) The magnetic powder is separated from the residue and dried.
(6) The ferromagnetic powder obtained in (4) and (5) is extracted using a special-purpose mesh to fabricate a TEM sample that is then photographed by a TEM.
(7) The major axis length of the ferromagnetic powder in the photograph is measured and averaged (the number of measurements n=100).

The ferromagnetic powder may constitute 70% by weight to 90% by weight of the magnetic layer 3 composition. If the included amount of ferromagnetic powder is too large, there will be a fall in the included amount of binder, making the magnetic layer 3 susceptible to deterioration in surface smoothness due to the calendering process. On the other hand, if the included amount of ferromagnetic powder is too small, a high reproduction output cannot be obtained.

There are no particular limitations on the binder (the “resin material” for the present invention) used in the magnetic layer 3, and it is possible to use a suitable combination of a thermoplastic resin, a thermosetting or reactive resin, an electron beam-curing binder, and the like in accordance with the properties and processing conditions of the magnetic tape 1.

The included amount of binder used in the magnetic layer 3 is preferably set in a range of 5 parts by weight to 40 parts by weight relative to 100 parts by weight of the ferromagnetic powder. If the included amount of binder is too small, the strength of the magnetic layer 3 falls, making the magnetic tape 1 susceptible to a fall in running durability. For this reason, the included amount of binder should more preferably be at least 10 parts by weight. On the other hand, if the included amount of binder is too large, there is a fall in the included amount of ferromagnetic powder, resulting in a tendency for a drop in the electromagnetic conversion characteristics. For this reason, the included amount of binder should more preferably be 30 parts by weight or less. Accordingly, the included amount of binder in the magnetic layer 3 should more preferably be in a range of 10 parts by weight to 30 parts by weight.

Also, to improve the mechanical strength of the magnetic layer 3 and prevent clogging of a magnetic head, the magnetic layer 3 should preferably include an abrasive, such as α-alumina (Mohs hardness=9), with a Mohs hardness of 6 or higher. This type of abrasive normally has an indeterminate form, and in addition to preventing clogging of the magnetic head, makes the magnetic layer 3 stronger.

The average particle diameter of the abrasive should preferably be set in a range of 0.01 μm to 0.2 μm, inclusive, for example. If the average particle diameter of the abrasive is too small, the amount by which the abrasive protrudes from the surface of the magnetic layer 3 becomes too small and there is the risk of the effect of preventing clogging of the magnetic head becoming insufficient. For this reason, abrasive with an average particle diameter of at least 0.05 μm should more preferably be included. Conversely, if the average particle diameter of the abrasive powder is too large, the amount by which the abrasive protrudes from the surface of the magnetic layer 3 becomes too large and there is the risk of a fall in the electromagnetic conversion characteristics, an increase in drop outs, an increase in abrasion of the magnetic head, and the like. For this reason, abrasive with an average particle diameter of 0.2 μm or less should more preferably be included. The average particle diameter of the abrasive is normally measured using a transmission electron microscope (TEM).

The included amount of abrasive should preferably be set in a range of 3 parts by weight to 25 parts by weight relative to 100 parts by weight of the ferromagnetic powder. If the included amount of abrasive is too small, there is the risk of the effect of preventing clogging of the magnetic head becoming insufficient. For this reason, the included amount of abrasive powder should more preferably be at least 5 parts by weight. Conversely, if the included amount of abrasive powder is too large, there is the risk of a fall in the electromagnetic conversion characteristics, an increase in drop outs, an increase in abrasion of the magnetic head, and the like. For this reason, the included amount of abrasive should more preferably be 20 parts by weight or less. In addition, a dispersant such as a surfactant, a lubricant such as a higher fatty acid, a fatty acid ester, and silicon oil, or other additives may be added to the magnetic layer 3 as necessary. Even if lubricant is not included in the magnetic layer 3 and lubricant is only included in the non-magnetic layer 2, since the lubricant included in the non-magnetic layer 2 will permeate through the magnetic layer 3 and be supplied to the surface of the magnetic layer 3, and therefore it is possible to construct the magnetic tape 1 without including lubricant in the magnetic layer 3 during manufacturing of the magnetic tape 1.

The magnetic coating composition for forming the magnetic layer 3 is prepared according to a well-known method by adding an organic solvent to the substances described above and carrying out processes such as mixing, agitating, kneading, and dispersing. There are no particular limitations on the organic solvent used, and it is possible to use the same substances used for the non-magnetic layer 2.

The center line average roughness Ra of the surface of the magnetic layer 3 should preferably be set in a range of 1.0 nm to 5.0 nm inclusive. If the center line average roughness Ra is below 1.0 nm, the surface of the magnetic layer 3 is too smooth, causing deterioration in running stability and making the magnetic tape 1 susceptible to problems during running. On the other hand, if the center line average roughness Ra exceeds 5.0 nm, the surface of the magnetic layer 3 becomes too rough, resulting in the electromagnetic conversion characteristics of the reproduction output and the like deteriorating. Accordingly, to significantly improve the running characteristics, the magnetic layer 3 should preferably be formed so that the center line average roughness Ra of the surface is at least 1.0 nm. Also, to significantly improve the electromagnetic conversion characteristics of the reproduction output and the like, the magnetic layer 3 should preferably be formed so that the center line average roughness Ra is 4.0 nm or less.

Back Coat Layer

The back coat layer 5 is formed to improve the running stability and to prevent the magnetic layer 3 from becoming electrically charged. Although there are no particular limitations on the structure or composition, as one example, it is possible to form the back coat layer 5 so as to include carbon black, non-carbon black non-magnetic inorganic powder, barium sulfate, and a binder (the “resin material” for the present invention). Here, the back coat layer 5 should preferably include 30% by weight to 80% by weight of carbon black. As the non-carbon black non-magnetic inorganic powder, it is possible to use acicular non-magnetic iron oxide (such as α-Fe₂O₃ or (—FeOOH), CaCO₃, TiO₂, BaSO₄, (α-Al₂O₃, or the like, and by doing so, it is possible to control the mechanical strength of the back coat layer 5 to a desired value.

The included amount of barium sulfate in the back coat layer 5 should preferably be in a range of 5 parts by weight to 12 parts by weight relative to 10 parts by weight of the solid content of the back coat layer 5. Here, if the included amount of barium sulfate is too small, it is difficult to sufficiently increase the strength of the back coat layer 5. Accordingly, to significantly improve the strength of the back coat layer 5, the included amount of barium sulfate should more preferably be at least 7 parts by weight relative to 100 parts by weight of the solid content of the back coat layer 5. On the other hand, if the included amount of barium sulfate is too large, the electrical resistance of the back coat layer 5 becomes too high, making it easy for dust to adhere during running and as described later, there is an increase in the amount of foreign matter produced, which can lead to recording/reproducing errors. Accordingly, to prevent dust from adhering and to sufficiently reduce the produced amount of foreign matter, the included amount of barium sulfate should more preferably be 10 parts by weight or less relative to 100 parts by weight of the solid content of the back coat layer 5. For this reason, by setting the included amount of barium sulfate in a range of 7 parts by weight to 10 parts by weight relative to 100 parts by weight of the solid content of the back coat layer 5, it is possible to improve durability (i.e., to avoid damage to the back coat layer 5) while sufficiently reducing the adhering amount of dust and produced amount of foreign matter.

The coating composition (back coat layer coating composition) for forming the back coat layer 5 is prepared according to a well-known method by adding an organic solvent to the substances described above and carrying out processes such as mixing, agitating, kneading, and dispersing. There are no particular limitations on the organic solvent used, and it is possible to use the same substances used for the non-magnetic layer 2.

The back coat layer 5 should preferably have a thickness of 1.0 μm or below after the calendering process. Here, if the back coat layer is too thin, there is the risk of difficulty in improving the running characteristics and obtaining a sufficient antistatic effect. Accordingly, the back coat layer 5 should be formed so that the thickness after calendering is at least 0.1 μm. Also, to significantly improve the running characteristics and to significantly improve the antistatic effect, the back coat layer 5 should preferably be formed so that the thickness after calendering is at least 0.2 μm. Conversely, if the back coat layer 5 is too thick, the cupping becomes too great (i.e., the curvature of the magnetic tape in the width direction becomes too great), resulting in the risk of difficulty in achieving proper contact with a magnetic head. Also, when the back coat layer 5 is too thick, it becomes difficult to reduce the overall thickness of the magnetic tape 1, resulting in a reduction in the length of tape that can be enclosed inside a cartridge case. That is, the storage capacity falls. Accordingly, the back coat layer 5 should more preferably be formed so that the thickness after calendering is 0.8 μm or less.

Manufacturing the Magnetic Tape 1

The magnetic tape 1 shown in FIG. 1 is manufactured by forming the non-magnetic layer 2, the magnetic layer 3, and the back coat layer 5 on the base film 4 by carrying out processes such as applying, drying, calendering, and hardening using the non-magnetic coating composition, the magnetic coating composition, and the back coat layer coating composition prepared as described above.

The non-magnetic layer 2 and the magnetic layer 3 are formed using a so-called “wet on dry” coating method. More specifically, first the non-magnetic coating composition is applied on one surface of the base film 4, the coating composition is dried, and then a calendering process is carried out as necessary to form the non-magnetic layer 2 in a pre-hardened state. After this, the pre-hardened non-magnetic layer 2 is subjected to 1.0 Mrad to 6.0 Mrad, inclusive of electron beam irradiation to harden the non-magnetic layer 2. Next, the magnetic coating composition is applied onto the hardened non-magnetic layer 2 and then orienting and drying processes are carried out to form the magnetic layer 3. Note that the back coat layer 5 may be formed at any time in the order of processes. That is, the back coat layer 5 can be formed before the non-magnetic layer 2 is formed, following the formation of the non-magnetic layer 2 but before the magnetic layer 3 is formed, or after the magnetic layer 3 has been formed.

As the method of applying the non-magnetic coating composition, the magnetic coating composition, and the back coat layer coating composition, a variety of well-known coating methods such as gravure coating, reverse roll coating, die nozzle coating, and bar coating can be used. As the barium sulfate included in the back coat layer 5, barium sulfate that has been subjected to a surface treatment using an inorganic material such as aluminum (Al) and silicon (Si) or an organic material such as carboxylic acid is used. Note that the amount of material used for the surface treatment should preferably be in a range of 0.1% by weight to 10.0% by weight of the barium sulfate. By doing so, it is possible to reduce the eluted amount of SO₄²⁻, as described later. The magnetic layer 3 and the back coat layer 5 are subjected as necessary to a calendering process after the coating films have been dried, for example. By doing so, the magnetic tape 1 is completed, as shown in FIG. 1.

Foreign Matter Produced from the Magnetic Tape

The applicant has found that by reducing the amount of α-iron oxide and α-iron hydroxide included in the non-magnetic layer 2 and the like that becomes Fe⁺ (i.e., is ionized) to a suitable range, it is possible to reduce the produced amount of fatty acid iron that is the main constituent of the fatty acid salts (a paste-like component of the produced foreign matter). The applicant has also found that there is a close relationship between the amount of α-iron oxide and the like that become ionized to Fe⁺ and the amount of SO₄²⁻ produced due to the barium sulfate included in the back coat layer 5 becoming ionized. Accordingly, by sufficiently reducing the amount of SO₄²− produced due to the barium sulfate becoming ionized, it is possible to reduce the amount of α-iron oxide and the like that become ionized to Fe⁺, and by doing so, it is possible to reduce the produced amount of fatty acid iron. As a result, it is possible to reduce the produced amount of fatty acid salt (i.e., foreign matter). Here, by reducing the amount of barium sulfate included in the back coat layer 5, it is possible to reduce the amount of SO₄²⁻ produced. However, if the included amount of barium sulfate is too small, as described earlier, it becomes difficult to sufficiently improve the strength of the back coat layer 5, resulting in the risk of deterioration in the running characteristics.

The applicant conducted detailed research into the conditions where the strength of the back coat layer 5 can be sufficiently improved while reducing the produced amount of foreign matter, and by doing so found that if the amount of SO₄²⁻ eluted when the magnetic tape 1 is immersed in water at 70° C. is 600 ppm or less relative to the weight of the magnetic tape 1, it is possible to sufficiently reduce the amount of α-iron oxide and the like that become ionized to Fe⁺, and by doing so, it is possible to sufficiently reduce the produced amount of fatty acid iron (i.e., the amount of foreign matter that adheres to a magnetic head). As a method of manufacturing the magnetic tape 1 to satisfy this condition, the applicant found that it is effective for the included amount of barium sulfate to be 12 parts by weight or less relative to 100 parts by weight of the solid content of the back coat layer 5. On the other hand, when the included amount of barium sulfate is below 5 parts by weight relative to 100 parts by weight of the solid content of the back coat layer 5, the strength of the back coat layer 5 falls, making the back coat layer 5 susceptible to damage. For a magnetic tape 1 where the included amount of barium sulfate is 5 parts by weight relative to 100 parts by weight of the solid content of the back coat layer 5, the eluted amount of SO₄²⁻ in the condition described above is 300 ppm. Accordingly, if the eluted amount of SO₄²⁻ is at least 300 ppm, the strength of the back coat layer 5 can be sufficiently increased.

In this way, in a magnetic tape 1 where lubricant is included in at least one of the non-magnetic layer 2 and the magnetic layer 3, at least one of α-iron oxide and α-iron hydroxide is included in the non-magnetic layer 2, and barium sulfate is included in the back coat layer 5, by forming the non-magnetic layer 2, the magnetic layer 3, and the back coat layer 5 so that the amount of SO₄²⁻ eluted when the magnetic tape 1 is immersed in water at 70° C. is in the range of 300 ppm to 600 ppm inclusive relative to the weight of the magnetic tape 1, it is possible to reduce the conversion to Fe⁺(i.e., the ionization) of the α-iron oxide and α-iron hydroxide included in the non-magnetic layer 2 to within a suitable range, and therefore it is possible to reduce the produced amount of fatty acid iron that is the main constituent of the fatty acid salts and therefore to sufficiently reduce the produced amount of foreign matter. Accordingly, with the magnetic tape 1, it is possible to reduce the production of recording/reproducing errors due to adhering foreign matter. Since it is possible to include a sufficient amount of barium sulfate in the back coat layer 5, it is possible to sufficiently improve the strength of the back coat layer 5 and therefore to sufficiently improve the durability of the magnetic tape 1. By doing so, it is possible to provide a magnetic tape 1 that can respond to demands for high-density recording to raise the data recording capacity.

### EXAMPLES

The magnetic tape 1 according to the present invention will now be described in detail with reference to examples.

### Example 1

Preparation of the Non-Magnetic Coating Composition

| | |
|---|---|
| Non-Magnetic Powder | |
| Acicular α-FeOOH | 80.0 parts by weight |
| (average major axis length: 0.1 μm, crystallite | |
| diameter: 12 nm) | |
| Carbon Black | 20.0 parts by weight |
| (Product Name: “#950B” made by Mitsubishi Chemical | |
| Corp., average particle diameter: 17 nm, BET specific | |
| surface area: 250 m²/g, DBP oil absorption: 70 ml/100 g, | |
| pH: 8) | |
| Electron Beam-Curing Binder | |
| Electron Beam-Curing Vinyl Chloride Resin | 12.0 parts by weight |
| (Product name “TB-0246” made by Toyobo Co., Ltd., | |
| (solid content) a copolymer of vinyl chloride and an | |
| epoxy-containing monomer, average degree of | |
| polymerization: 310, content of S based on the use of | |
| potassium persulfate: 0.6% (percentage by mass)), MR110 | |
| (made by Zeon Corporation of Japan) acrylic-modified | |
| using 2-isocyanatoethyl methacrylate (MOI), acrylic | |
| content: 6 mol/1 mol) | |
| Electron beam-curing polyurethane resin | 10.0 parts by weight |
| (Product name “TB-0216” made by Toyobo Co., Ltd., | |
| (solid content) hydroxy-containing acrylic compound - | |
| phosphonate group-containing phosphorus compound - | |
| hydroxyl-containing polyester polyol, average molecular | |
| weight: 13,000, P content: 0.2% (percentage by mass), | |
| acrylic content: 8 mol/1 mol) | |
| Dispersant | |
| High molecular weight polyester acid amide amine | 1.0 parts by weight |
| salt | |
| (Product name “DA-7500” made by Toho Chemical Industry Co., Ltd.) | |
| Abrasive | |
| α-alumina | 5.0 parts by weight |
| (Product name “HIT60A” made by Sumitomo Chemical Co. | |
| Ltd., average particle diameter: 0.18 μm) | |
| NV (solid concentration) = 33% (percentage by mass)) | |
| Solvent Proportions | |
| MEK/toluene/cyclohexanone = 2/2/1 (ratio by mass) | |

After the materials described above have been kneaded by a kneader, the mixture was dispersed using a horizontal pin mill filled with 0.8 mm zirconia beads to a fill ratio of 80% (a void ratio of 50 vol %). After this, the lubricants described below

Lubricant

| | |
|---|---|
| Fatty Acid | 1.0 parts by weight |
| (Product name: “NAA180” made by | |
| NOF Corporation) | |
| Fatty Acid Amide | 0.5 parts by weight |
| (Product name: “Fatty Acid Amide S” made by Kao | |
| Corporation) | |
| Fatty Acid Ester | 1.5 parts by weight |
| (Product name: “NIKKOLBS” made by | |
| Nikko Chemicals Co., Ltd.) | |

were added, and the mixture was diluted to achieve an NV (solid concentration)=25% (percentage by mass)) and solvent proportions of MEK/toluene/cyclohexanone=2/2/1 (ratio by mass), and then dispersed. After this, by passing the obtained material through a filter with an absolute filtering accuracy of 3.0 μm, the non-magnetic coating composition was fabricated.

Next, 0.2 parts by weight of a thermal hardener (“Colonate L” made by Nippon Polyurethane Industry Co., Ltd.) were added and mixed into the fabricated non-magnetic coating composition, and then by passing the composition through a filter with an absolute filtering accuracy of 1.0 μm, the non-magnetic coating composition for the present invention was fabricated.

Preparation of the Magnetic Coating Composition

| | |
|---|---|
| Ferromagnetic Powder | |
| Acicular Fe-based Ferromagnetic Powder | 100.0 parts by weight |
| (Fe/Co/Al/Y = 100/24/5/8 (atomic ratio), Hc: 188 kA/m, | |
| σs: 140 Am²/kg, BET specific surface area: 50 m²/g, and | |
| average major axis length: 0.10 μm) | |
| Binder | |
| Vinyl Chloride Copolymer | 10.0 parts by weight |
| (Product name: “MR110” made by Zeon Corporation of | |
| Japan) | |
| Polyester Polyurethane | 6.0 parts by weight |
| (Product name: “UR8300” made by Toyobo Co., Ltd.) | |
| Dispersant | |
| Phosphate surfactant | 3.0 parts by weight |
| (Product name: “RE610” made by Toho Chemical Industry | |
| Co., Ltd.) | |
| Abrasive Powder | |
| α-alumina | 10.0 parts by weight |
| (Product name: “HIT60A” made by Sumitomo Chemical Co. Ltd., | |
| average particle diameter: 0.18 μm) | |
| NV (solid concentration) = 30% (percentage by mass)) | |
| Solvent Proportions | |
| MEK/toluene/cyclohexanone = 4/4/2 (ratio by mass) | |

After the materials described above have been kneaded by a kneader, as a first-stage dispersing process, the mixture was dispersed using a horizontal pin mill filled with 0.8 mm zirconia beads to a fill ratio of 80% (a void ratio of 50 vol %).

After this, the mixture was diluted so that: NV (solid concentration)=15% (percentage by mass)); and solvent proportions of MEK/toluene/cyclohexanone=22.5/22.5/55 (ratio by mass), before a main (finishing) dispersing process was carried out. Next, after 10 parts by weight of a thermal hardener (“Colonate L” made by Nippon Polyurethane Industry Co., Ltd.) were added and mixed into the obtained coating composition, the composition was passed through a filter with an absolute filtering accuracy of 1.0 μm to fabricate the magnetic coating composition.

Preparation of the Back Coat Layer Coating Composition

| | |
|---|---|
| Carbon Black | 75 parts by weight |
| (Product name: “BP-800” made by Cabot | |
| Corporation, average particle diameter 17 nm, | |
| BET specific surface area 210 m²/g) | |
| Carbon Black | 10 parts by weight |
| (Product name: “BP-130” made by Cabot | |
| Corporation, average particle diameter 75 nm, | |
| DBP oil absorption 69 ml/100 g, BET specific | |
| surface area 25 m²/g) | |
| Surface-Treated Barium Sulfate | 10 parts by weight |
| (Product name: “Barifine BF-20” made by | |
| Sakai Chemical Industry Co., Ltd., average | |
| particle diameter 30 nm) | |
| Nitrocellulose | 50 parts by weight |
| (Product name: “BTH 1/2” made by Asahi Kasei | |
| Corporation) | |
| Polyurethane Resin | 40 parts by weight |
| (Product name: “UR-8300” made by Toyobo | |
| Co., Ltd., containing sodium sulfonate) | |
| MEK | 200 parts by weight |
| Toluene | 200 parts by weight |
| Cyclohexanone | 170 parts by weight |

Out of the composition described above, the surface-treated barium sulfate was subjected to a surface treatment according to the conditions given below.

After an agitating process was carried out for fifteen minutes using a Henschel mixer (manufactured by Mitsui Mining Co., Ltd.,), a polyhydric carboxylic acid solution was mixed in and the agitating process was continued for 30 minutes. After this, the solution in the mixer was transferred to a metal vat, and subjected to a drying process for 12 hours inside an draft chamber. When doing so, the amount of material used for the surface treatment was 4 parts by weight relative to 100 parts by weight of the barium sulfate.

After sufficiently kneading the composition described above using a kneader, dispersing was carried out for five hours using a sand grind mill. After this, the materials listed below were introduced and dispersing was carried out using a sand grind mill for one hour.

| | |
|---|---|
| MEK | 350 parts by weight |
| Toluene | 350 parts by weight |
| Cyclohexanone | 100 parts by weight |

15 parts by weight of a thermal hardener (“Colonate L” made by Nippon Polyurethane Industry Co., Ltd.) were added and mixed into the mixed solution obtained as described above, and by passing the obtained coating composition through a filter with an absolute filtering accuracy of 1.0 μm, the back coat layer coating composition was fabricated. When doing so, the included amount of barium sulfate after the surface treatment described above was 5 parts by weight relative to 100 parts by weight of the solid content of the back coat layer 5.

Non-Magnetic Layer Forming Process

The non-magnetic coating composition was applied by being extruded from a nozzle onto one surface of a base film 4 that is 6.2 μm thick and made of PEN and then dried so that the thickness after the calendering process is 2.0 μm. After this, calendering was carried out using a calender that is a combination of a plastic roll and a metal roll, where the material was nipped four times, the processing temperature was 100° C., the linear pressure was 3500 N/cm, and the speed was 150 m/min. In addition, 4.0 Mrad of electron beam radiation was applied to form the non-magnetic layer 2.

Magnetic Layer Forming Process

The magnetic coating composition was applied by a nozzle onto the non-magnetic layer 2 formed as described above so that the thickness after processing was 0.1 μm, and then an orienting process and a drying process were carried out. After this, calendering was carried out using a calender that is a combination of a plastic roll and a metal roll, where the material was nipped four times, the processing temperature was 100° C., the linear pressure was 3500 N/cm, and the speed was 150 m/min to form the magnetic layer 3.

Back Coat Layer Forming Process

The back coat layer coating composition was applied by a nozzle onto the other surface of a base film 4 made of PEN so that the thickness after processing was 0.5 μm, and then subjected to a drying process. After this, calendering was carried out using a calender that is a combination of a plastic roll and a metal roll, where the material was nipped four times, the processing temperature was 90° C., the linear pressure was 2100 N/cm, and the speed was 150 m/min to form the back coat layer 5.

The base film 4 made of PEN on which the series of processes described above has been completed was wound onto a winding roll, left in that state for 24 hours, thermally hardened for 48 hours at 60° C., and then cut up into ½ (=12.650 mm) inch-wide pieces to fabricate samples of the magnetic tape as example 1.

### Example 2

The amount of barium sulfate included in the back coat layer 5 was set at 15 parts by weight, and the other manufacturing conditions were set the same as for the magnetic tape of example 1 to fabricate samples of a magnetic tape as example 2. The included amount of surface-treated barium sulfate was 7 parts by weight relative to 100 parts by weight of the solid content of the back coat layer 5.

### Example 3

The amount of barium sulfate included in the back coat layer 5 was set at 22 parts by weight, and the other manufacturing conditions were set the same as for the magnetic tape of example 1 to fabricate samples of a magnetic tape as example 3. The included amount of surface-treated barium sulfate was 10 parts by weight relative to 100 parts by weight of the solid content of the back coat layer 5.

### Example 4

The amount of barium sulfate included in the back coat layer 5 was set at 27 parts by weight, and the other manufacturing conditions were set the same as for the magnetic tape of example 1 to fabricate samples of a magnetic tape as example 4. The included amount of surface-treated barium sulfate was 12 parts by weight relative to 100 parts by weight of the solid content of the back coat layer 5.

### Comparative Example 1

The amount of barium sulfate included in the back coat layer 5 was set at 6 parts by weight, and the other manufacturing conditions were set the same as for the magnetic tape of example 1 to fabricate samples of a magnetic tape as comparative example 1. The included amount of surface-treated barium sulfate was 3 parts by weight relative to 100 parts by weight of the solid content of the back coat layer 5.

### Comparative Example 2

The amount of barium sulfate included in the back coat layer 5 was set at 32 parts by weight, and the other manufacturing conditions were set the same as for the magnetic tape of example 1 to fabricate samples of a magnetic tape as comparative example 2. The included amount of surface-treated barium sulfate was 14 parts by weight relative to 100 parts by weight of the solid content of the back coat layer 5.

### Comparative Example 3

The amount of barium sulfate included in the back coat layer 5 was set at 9.6 parts by weight, and the other manufacturing conditions were set the same as for the magnetic tape of example 1 to fabricate samples of a magnetic tape as comparative example 3. However, for the magnetic tape of comparative example 3, the barium sulfate was not surface-treated. The included amount of barium sulfate was 5 parts by weight relative to 100 parts by weight of the solid content of the back coat layer 5.

Evaluation of the Magnetic Tapes

The various magnetic tape samples of embodiments 1 to 4 and comparative examples 1 to 3 were subjected to evaluation tests relating to the included amount of barium sulfate, the eluted amount of soluble ions, the amount of foreign matter adhering to the magnetic head, and extent of damage to the back coat layer 5 according to the method described below.

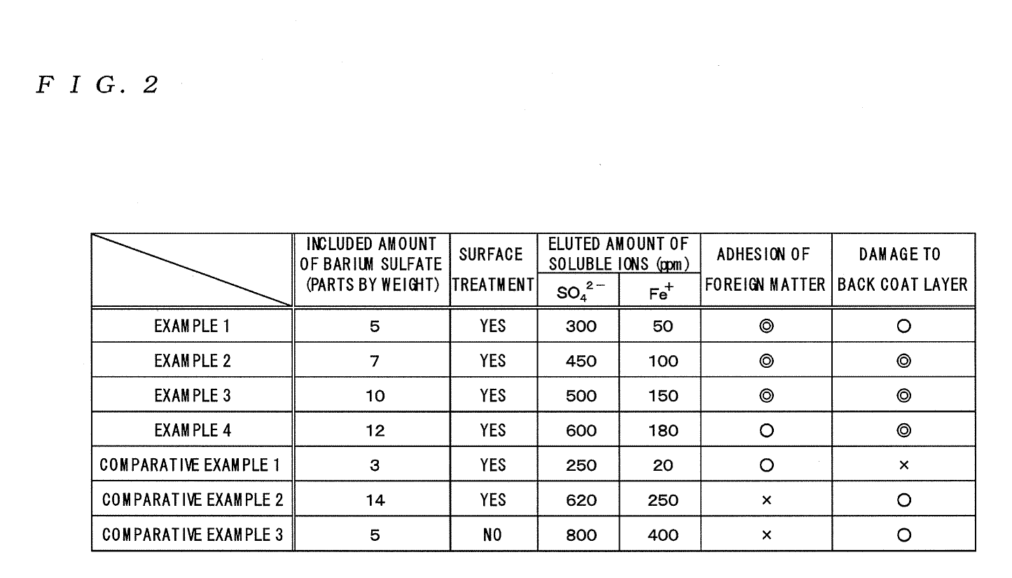

Measuring the Included Amount of Barium Sulfate The weights of the samples of examples 1 to 4 and comparative examples 1 to 3 after removal of the non-magnetic layer 2 and the magnetic layer 3 using an organic solvent (i.e., samples where only the back coat layer 5 is laminated on the base film 4) were measured. Next, the samples were burnt (i.e., the organic material was removed), the burnt residue was subjected to alkaline fusion, 6N hydrochloric acid was added, and the residue was heated and dissolved. The weight of barium ions was determined from the resulting solution using ICP (Inductively Coupled Plasma), and the amount of barium sulfate was calculated based on the determination results and measurement results for the weights of the samples after removal of the non-magnetic layer 2 and the magnetic layer 3. The same procedure was used to determine the amount of barium ions for the base film 4 alone, and the amount of barium sulfate was calculated based on the determination result and the weight for the base film 4 alone. By subtracting the calculation result for the base film 4 alone from the calculation result for the base film 4 and the back coat layer 5, the amount of barium sulfate included in the back coat layer 5 was calculated. The included amounts of barium sulfate determined (calculated) in this way are shown in FIG. 2. Note that an ICPS-8000 (made by Shimadzu Corp.) was used to determine the amount of barium ions using ICP.

Measurement of Eluted Amount of Soluble Ions

One meter of tape with a width of half an inch was immersed in around 40 cc of ion-exchanged water (or purified water) that had been heated to 70° C. and was shaken for one hour. Next, after the solution had cooled to room temperature, the solution was filtered using 1 μm filter paper (No. 5) and then further filtered using a 0.22 μm PP filter, with the amount of soluble ions then being determined using the filtrate obtained by such filtering.

In this case, the eluted amount of SO₄²⁻ was determined according to the following conditions.
Ion Chromatography: DX500 (made by DIONEX)
Columns: IonPac AG15, AS15
Elution: 20 mmol/L to 40 mmol/L, KOH gragient
Flow rate: 1.2 mL/min
Introduced amount: 25 μL
Forms of detectors: suppressed electrical conductivity detection

The amount of eluted Fe⁺ was determined using ICP by an ICPS-8000 (made by Shimadzu Corporation).

The eluted amounts of soluble ions determined in this way are shown in FIG. 2. Note that the eluted amounts shown in FIG. 2 are expressed by figures relative to the weights of the respective samples (the entire weights of the magnetic tapes).

Adhering Amount of Foreign Matter

A tape was run for 48 hours and the foreign matter (in particular white-colored foreign matter) adhering to the drive apparatus was observed using an optical microscope. Samples where no adhering foreign matter was observed are indicated by double circles in FIG. 2, samples where an extremely small amount of adhering foreign matter was observed are indicated by circles, and samples where foreign matter that could cause recording/reproducing errors was observed are indicated by crosses.

Note that a “DLT-4000” (made by Quantum Corporation) was used as the drive apparatus.

Damage to the Back Coat Layer

One half-inch wide tape was placed in contact with one quarter (i.e., 900) of the circumference of a cylindrical SUS pin with a diameter of 2 mm, and the tape was run back and forth 2000 times at room temperature with a speed of 30 mm/sec and an applied load of 50 g. In FIG. 2, samples where no damage was observed with the human eye are indicated by double circles, samples where only extremely small scratches that do not cause problems for the tape running characteristics were observed are indicated by circles, and samples where scratches that could cause deterioration in the tape running characteristics were observed are indicated by crosses.

As shown in FIG. 2, scratches large enough to cause deterioration in the tape running characteristics were not observed in the back coat layer 5 of the magnetic tapes of the examples 1 to 4 and the comparative examples 2 and 3 where the eluted amount of SO₄²⁻ is at least 300 ppm relative to the weight of the magnetic tape. On the other hand, scratches large enough to cause deterioration in the tape running characteristics were observed in the back coat layer 5 of the magnetic tapes of the comparative example 1 where the eluted amount of SO₄²⁻ is below 300 ppm relative to the weight of the magnetic tape (in this example, 250 ppm). Accordingly, it can be understood that by forming the non-magnetic layer 2, the magnetic layer 3, and the back coat layer 5 so that the eluted amount of SO₄²⁻ is at least 300 ppm relative to the weight of the magnetic tape, it is possible to manufacture a magnetic tape where the strength of the back coat layer 5 is sufficiently increased and therefore resistant to damage (i.e., the magnetic tape has high durability). Also, as shown in FIG. 2, it can be understood that by setting the included amount of barium sulfate at at least 5 parts by weight relative to 100 parts by weight of the solid content of the back coat layer 5, it is possible to manufacture a magnetic tape where the eluted amount of SO₄²⁻ is at least 300 ppm relative to the weight of the magnetic tape.

On the other hand, with the magnetic tapes of the examples 1 to 4 and comparative example 1 where the eluted amount of SO₄²⁻ is no greater than 600 ppm relative to the weight of the magnetic tape, the eluted amount of Fe⁺ is suppressed to 180 ppm or less, and by doing so, a state where hardly any foreign matter adheres to the magnetic head is produced. On the other hand, for the magnetic tapes of comparative examples 2 and 3 where the eluted amount of SO₄²⁻ relative to the weight of the magnetic tape exceeds 600 ppm (in this example, 620 ppm or more), it was confirmed that the eluted amount of Fe⁺ is 250 ppm or greater and an amount of foreign matter that could cause recording/reproducing errors adheres to the magnetic head. Accordingly, it can be understood that by forming the non-magnetic layer 2, the magnetic layer 3, and the back coat layer 5 so that the eluted amount of SO₄²⁻ is 600 ppm or less relative to the weight of the magnetic tape, it is possible to manufacture a magnetic tape where there is a sufficient reduction in the produced amount of foreign matter (i.e., the amount of foreign matter that adheres to a magnetic head or the like), which makes it difficult for recording/reproducing errors to be caused by adhering foreign matter. Also as shown in FIG. 2, it can be understood that by setting the included amount of barium sulfate at 12 parts by weight or below relative to 100 parts by weight of the solid content of the back coat layer 5, it is possible to manufacture a magnetic tape where the eluted amount of SO₄²⁻ is 600 ppm or below.

From the points given above, by forming the non-magnetic layer 2, the magnetic layer 3, and the back coat layer 5 so that the eluted amount of SO₄²⁻ is in a range of 300 ppm to 600 ppm inclusive relative to the weight of the magnetic tape, it is possible to manufacture a magnetic tape where the produced amount of foreign matter can be sufficiently reduced while still improving the durability of the magnetic tape. Also, by setting the included about of barium sulfate in a range of 5 parts by weight to 12 parts by weight inclusive relative to 100 parts by weight of the solid content of the back coat layer 5, it is possible to manufacture a magnetic tape where the eluted amount of SO₄²⁻ is in a range of 300 ppm to 600 ppm inclusive relative to the weight of the magnetic tape.

For the magnetic tapes of examples 2 to 4 where the eluted amount of SO₄²⁻ is 450 ppm or above relative to the weight of the magnetic tape, the durability is improved to an extent where damage to the back coat layer 5 could not be observed. Accordingly, it can be understood that by forming the non-magnetic layer 2, the magnetic layer 3, and the back coat layer 5 so that the eluted amount of SO₄²⁻ is at least 450 ppm relative to the weight of the magnetic tape, it is possible to manufacture a magnetic tape with high durability where damage to the back coat layer 5 can be almost completely avoided. Note that as shown in FIG. 2, by setting the included amount of barium sulfate at at least 7 parts by weight relative to 100 parts by weight of the solid content of the back coat layer 5, it is possible to manufacture a magnetic tape where the eluted amount of SO₄²⁻ is at least 450 ppm relative to the weight of the magnetic tape.

Also, for the magnetic tapes of the examples 1 to 3 where the eluted amount of SO₄²⁻ is 500 ppm or less relative to the weight of the magnetic tape, the produced amount of foreign matter is reduced to an extent where adhesion of foreign matter to a magnetic head is not observed. Accordingly, it can be understood that by forming the non-magnetic layer 2, the magnetic layer 3, and the back coat layer 5 so that the eluted amount of SO₄²⁻ is 500 ppm or less relative to the weight of the magnetic tape, it is possible to manufacture a magnetic tape where hardly any foreign matter is produced. Note that as shown in FIG. 2, by setting the included amount of barium sulfate at 10 parts by weight or less relative to 100 parts by weight of the solid content of the back coat layer 5, it is possible to manufacture a magnetic tape where the eluted amount of SO₄²⁻ is 500 ppm or less relative to the weight of the magnetic tape.

What is claimed is:

1. A magnetic recording medium where at least a non-magnetic layer and a magnetic layer are formed in the mentioned order on one surface of a non-magnetic support and a back coat layer is formed on the other surface of the non-magnetic support,
wherein the non-magnetic layer is formed so as to include resin material and at least one of α-iron oxide and α-iron hydroxide,
the magnetic layer is formed so as to include a ferromagnetic alloy powder and a resin material,
the back coat layer is formed so as to include carbon black, barium sulfate, and a resin material,
at least one of the non-magnetic layer and the magnetic layer includes lubricant, and
the non-magnetic layer, the magnetic layer, and the back coat layer are formed so that an amount of SO₄²⁻ eluted when the magnetic recording medium is immersed in water at 70° C. is in a range of 300 ppm to 600 ppm inclusive relative to a weight of the magnetic recording medium.
